(19) United States
(12) Patent Application Publication
(10) Pub. No.: US 2019/0126174 A1
(43) Pub. Date: May 2, 2019

(54) WATER FILTRATION SYSTEM

(71) Applicant: Blue Planet Group Ltd., Nassau (BS)

(72) Inventors: Andrew W. LOMBARDO, Pompano Beach, FL (US); Symon P. THOMAS, Ann Arbor, MI (US)

(73) Assignee: Blue Planet Group Ltd., Nassau (BS)

(21) Appl. No.: 16/176,398

(22) Filed: Oct. 31, 2018

Related U.S. Application Data
(60) Provisional application No. 62/579,589, filed on Oct. 31, 2017.

(51) Int. Cl. B01D 29/01

(52) U.S. Cl. CPC B01D 29/01

(57) ABSTRACT

A water filtration system includes a raw water reservoir that holds raw water. The system also includes a gravity filtration assembly to remove particles from the water as it passes through from the raw water reservoir. The filter of the assembly includes immobilized filter media within an enclosure.

### FIELD OF THE INVENTION

The present disclosure provides a description of a gravity-based filter utilizing an immobilized media such that the flow of water changes uniformly, or nearly uniformly for the filter surface as head height changes. This feature optimizes the head height to filter surface to give the best possible head height and uniform performance.

### DESCRIPTION OF THE RELATED ART

Most gravity filters that are commercially available are either made from granular media or immobilized into a cylindrical filter. The filters that are granular based have many issues related to them. The granular based filters are very prone to channeling (water finds an easy path through the media) and the performance/user experience can vary if the media inside the shell is not perfectly level. Medias also change in performance as the particles get packed down over time. In addition to these drawbacks, the size of the media that can be used in this style of filter is greatly limited as well. Particles cannot be too small, or risk being washed away when the user first puts water into the device. This limit in particle size for the granular based filters also limits the removal performance, as removing chemicals from water is often kinetically limited and the larger the particles being used, the slower the particles can typically remove the contaminants from the water.

Immobilized filters remove this kinetic limitation by allowing filters to use smaller particle sizes in the filter, but typical gravity immobilized gravity filters have only been made cylindrical to match production capabilities that are currently being utilized for pressurized filters. The flow for these filters starts either from the center of the cylinder, to the outside (inside out), or from the outside flowing into the center core (outside in). These filters typically hang down from the top reservoir of a gravity filter system, and the top of the filter sees a different head pressure than the bottom, so the performance on the filter itself changes depending where you are on the filter. Eventually, the preferential flow the lower section sees results in premature breakthrough of contaminates.

### SUMMARY OF THE INVENTION

The present invention discloses a new style of gravity-based filter that optimizes performance and maximizes flow by ensuring that the pressure on the surface of the filter changes uniformly as the head height of the water changes. This immobilized filter allows for the use of smaller particles to increase kinetics, maximizes the head height on the surface of the filter, and maintains uniform flow rate and performance as the water flows through the filter.

The present invention relates to gravity filter devices that remove contaminants from liquids, such as water. The gravity filter device may be used with home water filtration systems. The top reservoir may be for storage of raw water from a source. The disclosed embodiments differ from known gravity filter devices in that they are not made with loose media held in a container. Instead, an immobilized filter is disclosed that acts as a gravity filter distinguishable from known cylindrical filters on the market.

The disclosed embodiments disclose a unique gravity-based filter that optimizes performance and maximizes flow by ensuring that the pressure on the surface of the filter changes uniformly as the head height of the water changes. The immobilized filter allows for the use of smaller particles to increase kinetics, maximize the head height of the surface available for the filter, and maintains uniform flow rate and performance as the water flows through the filter.

A water filtration system is disclosed. The water filtration system includes a raw water reservoir. The water filtration system also includes a filter to provide passage from the raw water reservoir. The filter comprises an immobilized filter media, such that a flow of water through the filter changes uniformly, or almost uniformly, with a change in head pressure. The flow of water is achieved by gravity pressure and shows a total minimum pressure greater than 0.072 psi when the raw water reservoir is completely full, and a total volume of the filter is greater than 16 cubic centimeters.

A gravity filtration assembly to filter water is disclosed. The gravity filtration assembly includes an enclosure. The gravity filtration assembly also includes immobilized filter media within the enclosure. The filter media does not move within the enclosure. The gravity filter assembly creates a head height for the water above a top surface of the filter media and a total filter volume greater than 16 cubic centimeters for water flowing through the filter media. The total head height is greater than 2 inches when the top reservoir is full.

A filter having an immobilized gravity filter media is disclosed. The immobilized gravity filter media is arranged such that a pressure applied to a filter surface changes nearly uniformly as a head pressure in a filtration device changes, and water flows through the filter with a total filter volume greater than 16 cubic centimeters and a total pressure applied on the filter surface greater than 0.072 psi by gravity head pressure when the top reservoir is full.

An immobilized gravity filter configured to have a density of the filter equal to or greater than 0.43 g/cc.

Methods and associated processes for using the water filtration system, the gravity filtration assembly, the filter and the immobilized gravity filter may be disclosed. Water may be placed into the top reservoir. A uniform pressure is applied to the top of the gravity filter media. The water flows through the immobilized gravity filter. The pressure changes as the head pressure on the upper surface of the filter media changes. Contaminants are removed from the water by the filter media. The filtered water is collected in a clean water reservoir.

### BRIEF DESCRIPTION OF THE DRAWINGS

Various other features and attendant advantages of the present invention will be more fully appreciated as the same becomes better understood when considered in conjunction with the accompanying drawings.

FIG. 1 illustrates a perspective view of a water filtration system according to the disclosed embodiments.

FIG. 2 illustrates a side view water filtration system according to the disclosed embodiments.

FIG. 3 illustrates a side view of the water filtration system with the filter moved according to the disclosed embodiments.

FIG. 4 illustrates a side view of another water filtration system according to the disclosed embodiments.

FIG. 5 illustrates a side view of the filter according to the disclosed embodiments.

FIG. 6 illustrates another filter according to the disclosed embodiments.

FIG. 7 illustrates another filter according to the disclosed embodiments.

### DETAILED DESCRIPTION OF THE PREFERRED EMBODIMENTS

Reference will now be made in detail to specific embodiments of the present invention. Examples of these embodiments are illustrated in the accompanying drawings. While the embodiments will be described in conjunction with the drawings, it will be understood that the following description is not intended to limit the present invention to any one embodiment. On the contrary, the following description is intended to cover alternatives, modifications, and equivalents as may be included within the spirit and scope of the appended claims. Numerous specific details are set forth in order to provide a thorough understanding of the present invention.

The present invention differs from known gravity filter devices as it incorporates an immobilized filter that attaches to the bottom or end of the raw water reservoir. Most known filters used today in water filtration systems have loose media held in a cylindrical container, which limits the contaminants that can be removed. There also is a lack of uniformity from filter to filter due to the possibility of channeling through the media. “Channeling” refers to the water moving along a path repeatedly. Most immobilized filter assemblies are cylindrical in nature with water flowing radially from outside the filter to an inside passage. This process may cause its own issues including having air bubbles trapped on the inside of the filter. Further, the top of a cylindrical filter will experience a different pressure than the bottom of the filter as well as non-uniform flow, and difference in filter utilization. The filter media at the bottom of the cylindrical filter will be used more often than that at the top.

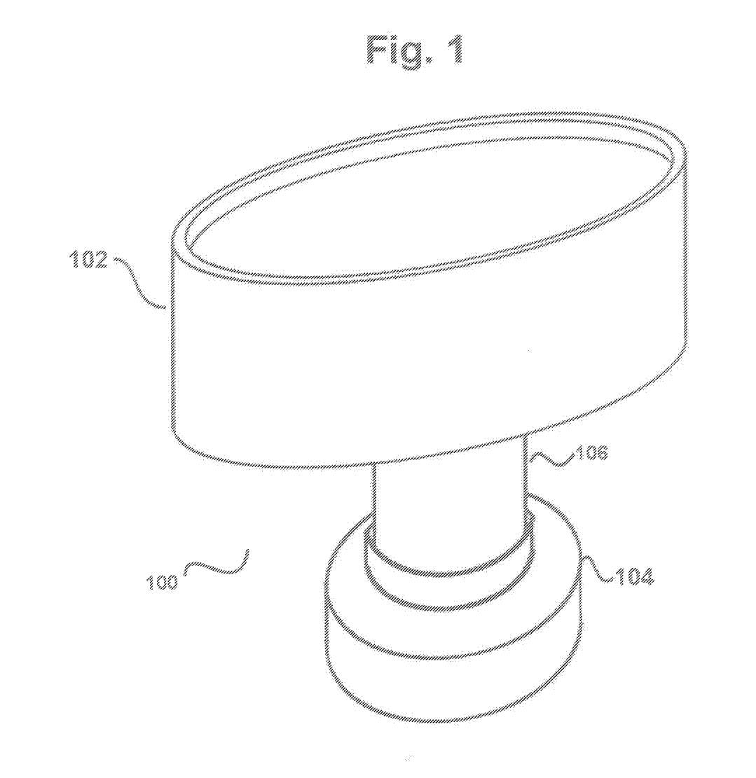

FIG. 1 depicts a perspective view of a water filtration system 100 according to the disclosed embodiments. Water filtration system 100 may include two components. Raw water reservoir 102 holds water from outside the system that is to be filtered. The water flows from water reservoir 102 through filter 104, which is attached to the bottom of the reservoir. Filter 104 also may be known as a gravity filter assembly. A passage 106 may connect the upper part of the reservoir to filter 104. In some embodiments, passage 106 may be shaped to fit into an aperture (described in greater detail below) within the enclosure for filter 104.

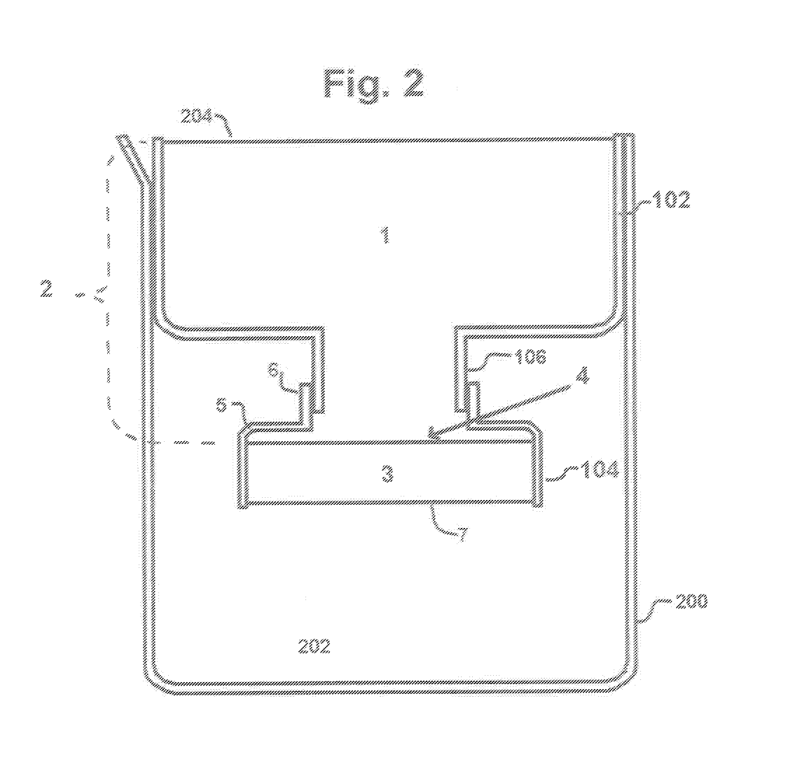

FIG. 2 depicts a side view of water filtration system 100 according to the disclosed embodiments. The side view shows water 1 within raw water reservoir 102. Water 1 may have a head height 2, which is the height from an upper surface 4 of filter media 3 within filter 104 to the water level when filled completely. Water 1 flows through filter 104 into clean water reservoir 202. Clean water reservoir 202 along with the rest of water filtration system 100 may be enclosed with a container 200. Thus, water 1 is placed into water filtration system 100 to be filtered and then available for drinking or other uses within container 200.

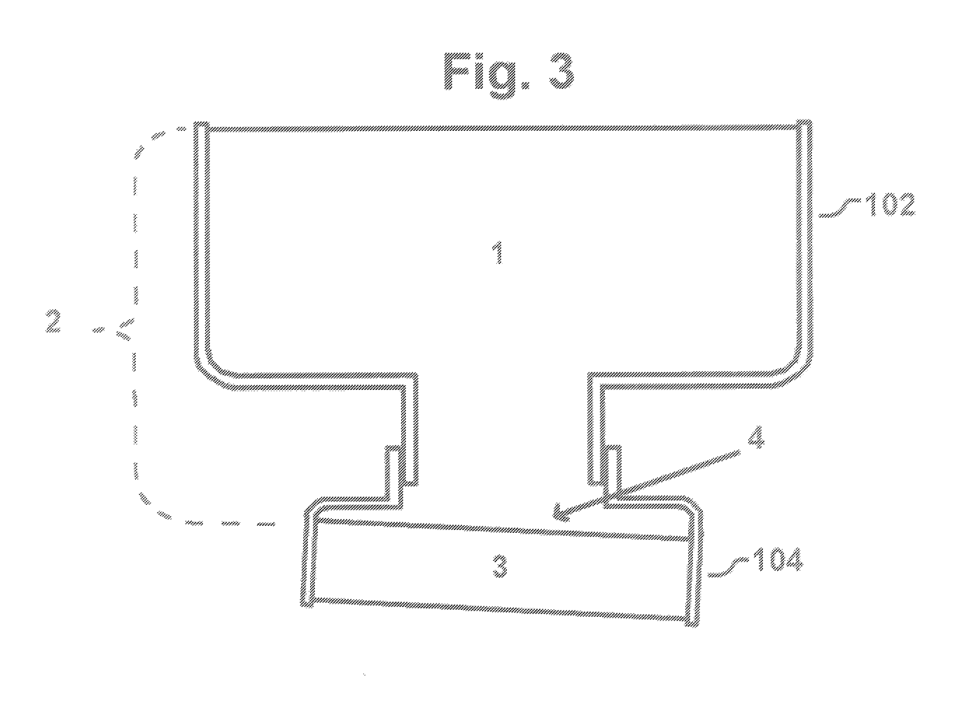

Filter 104 includes filter media 3. Filter media 3 is an immobilized filter media in that the media is not loose. Movement of filter media 3, as shown in FIG. 3, does not impact the shape of the filter media. The filter particles do not Move when filter 104 is moved. The particles do not shift within filter 104. Filter media 3 is packed and immobilized. Thus, filter 104 does not experience channeling as is the case in loose media filters. Channeling refers to when part of the filter is denser, or has a higher level of particles, and water preferentially flows in one portion of the filter. Filter 104 also does not suffer from the pitfalls of cylindrical filters where a portion is exposed to water, such as the bottom of the cylindrical filter, and another part is not, such as the top. The density of filter media 3 also promotes removal of more contaminants from water 1.

Loose media allows for the pore size and tortuous path to change whenever the filter is moved. The particles can move and shift. If shifted in a particular way, then the water can flow through just one area or path in the filter, or at least flow more towards that area or path than other areas within the granular-based filter. Filter 104 is an immobilized filter. The particles do not move and the pore structure of the filter is set in place. Water will flow in the manner that is was designed to flow and the water cannot avoid the bulk of the media.

Filter 104 also includes enclosure 5 to encapsulate filter media 3. Enclosure 5 includes connecting portion 6 that engages with passage 106 to attach to raw water reservoir 102. In some embodiments, connecting portion 6 may include threaded portions that engage with threaded portions on passage 6 to secure to the reservoir. In other embodiments, connecting portion 6 may be fitted to passage 106. In further embodiments, there is not passage 106 in that water reservoir 102 connects the upper chamber 204 directly with filter 104. Filter media 3 includes an upper surface 4 and a lower surface 7. Water 1 enters filter media 3 at upper surface 4 and exits at lower surface 7. The surfaces also may be known as enter surface 4 and exit surface 7. As shown, lower surface 7 is offset from the bottom of clean water reservoir 202.

Head height 2 is shown. Head height may be the height or distance from top surface 4 and the top of water 1. A greater head height 2 results in more pressure on filter 104. For example, there may be 0.031 psi per inch of water 1 in raw water reservoir 102. As the height of the water increases, the pressure on the filter also increases, such as when something is placed deeper into a pool. The greater the head pressure, the better the flow through filter 104. The disclosed embodiments work better with greater head pressure. In contrast, loose media filters operate better under low head pressure conditions.

Preferably, water flow through filter 104 is achieved by gravity. Because filter media 3 is immobilized, the flow through filter 104 changes uniformly or nearly uniformly with a change in head pressure. The head pressure on filter media 3 also remains uniform across top surface 4, which prevents channeling. Water flow is perpendicular or nearly perpendicular to filter 104. Preferably, filter 104 and filter media 3 are located at the bottom of water filtration system 100. This results in greater head pressure due to higher head height 2.

In some embodiments, the water flow is promoted by gravity pressure. The water flow may show a total maximum water pressure by a head height greater than 0.072 psi. Further, the total volume of filter 104 may be greater than 16 cubic centimeters. Preferably, head height 2 is greater than 2 inches. In other words, the disclosed embodiments provide for an immobilized gravity filter media 3 within filter 104 arranged such that the pressure applied to the filter surface changes uniformly or nearly uniformly as the head pressure in raw water reservoir 102 changes. Water 1 flows through filter 104 into clean water reservoir 202 with a total filter volume greater than 16 cubic centimeters and a total pressure applied on upper surface 4 greater than 0.072 psi by gravity head pressure. Thus, passage 106 may be narrower than upper chamber 204 of raw water reservoir 102 to increase head pressure on filter media 3.

The disclosed embodiments, therefore, seek to maximize head height 2 within water filtration system 100. As noted above, head height 2 above two inches improves the flow rate through the filter. It also enables a wider filter surface and slows down the linear velocity, or face velocity, of the water through filter 104. This feature provides better absorption with the slower linear velocity because particles are distributed over a larger area along with more contact time. As opposed to water 1 flowing rapidly through filter 104, the flow rate is slowed down so that the contaminants may be removed. Further, more contaminants may be removed from water 1. Finer particles also may be removed by filter 104. Moreover, filter media 3 may be made denser to remove contaminants because the pressure is increased due to the configuration of filter 104.

As can be appreciated, no minimum volume is necessary for use of water filtration system 100. The size of the system may be scaled using the disclosed filter from very small to handle a few milliliters up to the size of a refrigerator. The principles disclosed herein would still apply. Preferred items in the filter or the filter media may include carbon, zeolite, lead scavengers, heavy metal scavengers, bone char, metal hydroxides, metal oxides, metal carbonates, and the like.

FIG. 3 depicts water filtration system 100 with filter 104 shifted so that it is not perpendicular to the water flow from raw reservoir 102. FIG. 3 shows that filter media 3 does not shift within filter 104. Further, water 1 still comes into contact with upper surface 4 to provide the features disclosed above. This allows for air that may be trapped on the filter surface to roll off and not impede flow. The tilted filter allows for any bubbles of air that gets trapped when the level of water increases over the filter itself to roll off, thereby not causing a restriction in flow rate. Filter media 3 may be angled slightly in FIG. 3. For example, the angle of the shift may be between about 0 degrees to 25 degrees. More preferably, the angle may be about 0 degrees to 5 degrees. This angle also may be greater than 25 degrees in some instances.

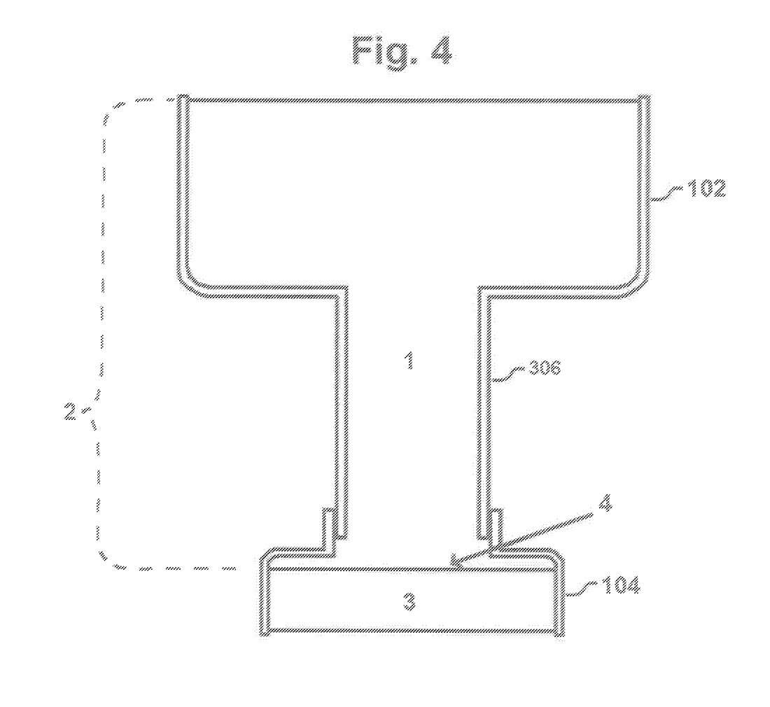

FIG. 4 depicts another water filtration system 100 having a greater head height 2. In essence, passage 306 is longer than passage 106 disclosed above. This provides for a greater head height 2, which, in turn, results in greater gravity water pressure. Passage 306 (or 106) may be configured to have a minimum head height of 2 inches such that water flow is initiated through filter 104.

The flow rate of the water filtration system shown in FIG. 4 may be increased due the other greater head height 2. The greater height of the water increases the head height on filter 104. Thus, one may vary flow through filter 104, and within water filtration system 100, by using different lengths for passages. A faster flow rate also results in less time to filter the water for use.

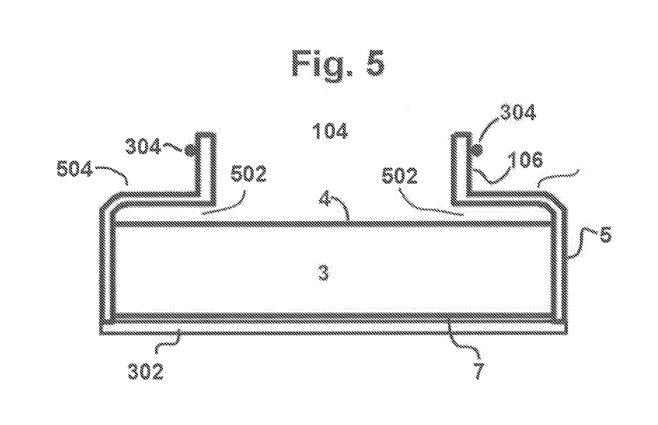

FIG. 5 depicts a side view of filter 104 according to the disclosed embodiments. Filter 104 in FIG. 5 is detached from raw water reservoir 102. Filter 104 includes filter media 3 within enclosure 5. Enclosure 5 may be made from materials such as plastic, metal, glass, and the like. As shown, filter media 3 is fitted within enclosure 5. Connecting portion 6 extends upwards from enclosure 5 and includes one or more tabs 304. A sealing mechanism such as, but not limited to, “O” or “X” rings 304 that may be fitted to the filter 104 to ensure a seal to the top reservoir and place it onto raw water reservoir 102. Filter media 3 also includes upper surface 4 and lower surface 7. Bottom part 302 may cover lower surface 7 to protect filter media 3 from being damaged when filter 104 is not in use.

As disclosed above, filter media 3 includes packed materials to filter water 1 as it flows through filter 104. Preferably, the density of filter media 3 is about equal to or greater than 0.43 g/cc. This density provides the features disclosed above with regard to removing contaminants from the water. Filter media 3 also may include a binder to pack and hold the filter materials. In some embodiments, the binder may be hydrophobic.

Spaces 502 may be formed between upper surface 4 and upper portions 504 of enclosure 5. Spaces 502 allow for the water to evenly distribute to upper surface 4 of filter media 3. Spaces 502 also allow for air bubbles to be removed. Air bubbles may cause a restriction to water flow through filter media 3. Thus, the disclosed embodiments may utilize spaces 502 to remove the air bubbles from upper surface 4 to reduce any possible impact to the flow of water therethrough.

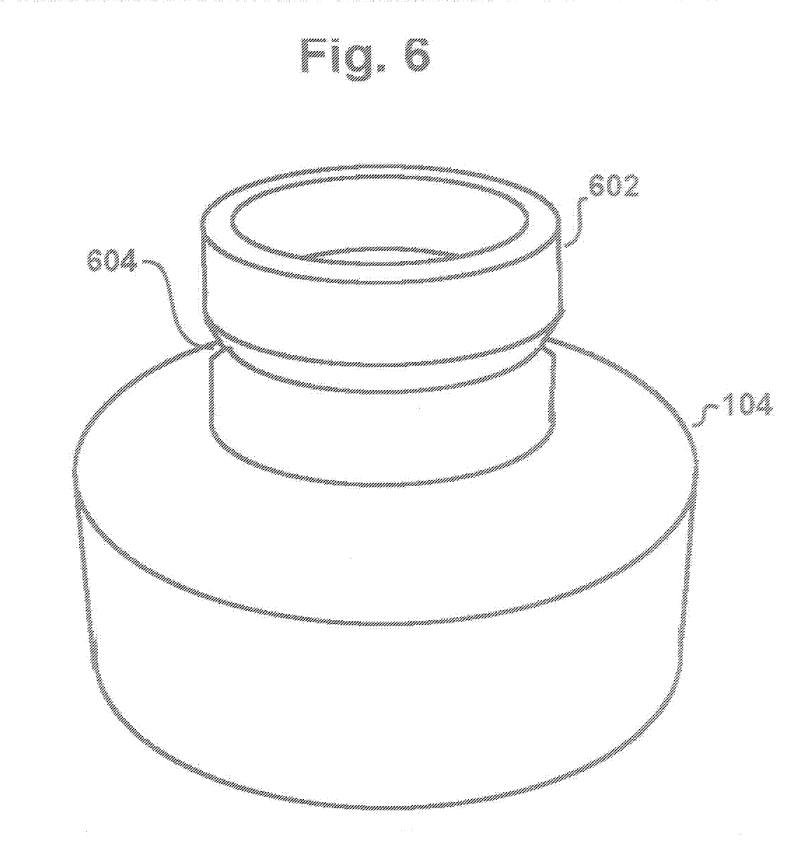

FIG. 6 depicts a perspective view of filter 104 with connecting portion 602 according to the disclosed embodiments. Connecting portion 602 extends outwardly for a greater distance than the connecting portion disclosed above. Connecting portion 602 also includes indented portion 604 that may provide a stop in placing filter 104 on raw water reservoir 102 or for a method to seal to the top reservoir or both. This feature may protect filter media 3 from being struck by passage 106 or 306 as filter 104 is connected.

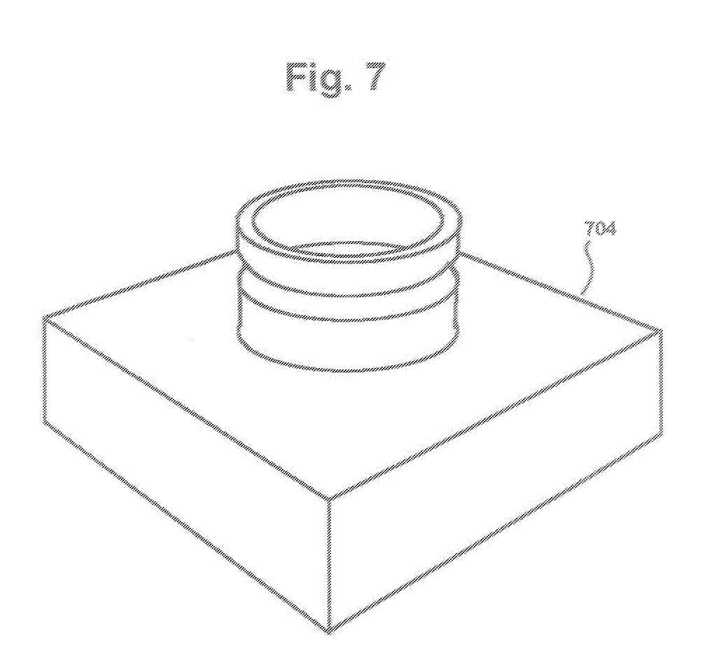

FIG. 7 depicts another filter 704 according to the disclosed embodiments. The filters above have been shown as circular, or “puck” shaped. The filters within the disclosed water filtration system do not need to be circular and can be virtually any shape. Filter 704 includes a square shape. The filter media within filter 704 may be the shape of a square as well. The shape used within the water filtration system may be dictated by function or need, or may just be aesthetically pleasing.

Thus, a water filtration system is disclosed that uses an immobilized filter to treat water. The pressure on the upper surface of the filter changes uniformly with the head height of the water. The immobilized filter also allows for the use of smaller particles. The particles do not move and shift during use. Channels or other uneven flow issues are avoided as well. The disclosed water filtration system optimizes head height to the filter surface to give improved performance and to maintain uniform flow rate.

It will be apparent to those skilled in the art that various modifications to the disclosed immobilized gravity filtration system without departing from the spirit or scope of the invention. Thus, it is intended that the present invention covers the modifications and variations disclosed above provided that these changes come within the scope of the claims and their equivalents.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

In the foregoing and in the examples, all temperatures are set forth uncorrected in degrees Celsius and, all parts and percentages are by weight, unless otherwise indicated.

The entire disclosures of all applications, patents and publications, cited herein and of corresponding U.S. Provisional Application Ser. No. 62/579,589, filed Oct. 31, 2017, are incorporated by reference herein.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

1. A water filtration system comprising:
a raw water reservoir;
a filter to provide passage from the raw water reservoir to the clean water reservoir, wherein the filter comprises an immobilized filter media, such that a flow of water through the filter changes uniformly, or almost uniformly, with a change in head pressure, and
wherein the flow of water is achieved by gravity pressure and shows a total minimum water pressure by a head height greater than 0.072 psi when the top reservoir is completely full, and a total volume of the filter is greater than 16 cubic centimeters.

2. The water filtration system of claim 1, further comprising a container to enclose the raw water reservoir and the filter.

3. The water filtration system of claim 1, wherein the filter is located at a position offset from the bottom of the clean water reservoir and a head pressure is maximized.

4. The water filtration system of claim 1, wherein the filter includes a top surface and a bottom surface of the filter media.

5. The water filtration system of claim 4, wherein a water pressure on the top surface of the filter is uniform.

6. The water filtration system of claim 1, wherein the filter media includes a binder.

7. The water filtration system of claim 1, wherein the filter includes a side wall to enclose the filter media, the side wall having a height.

8. The water filtration system of claim 7, wherein the side wall attaches the filter to the raw water reservoir.

9. A gravity filtration assembly to filter water comprising;
an enclosure; and
immobilized filter media within the enclosure, wherein the filter media does not move within the enclosure,
wherein the gravity filter assembly creates a head height for the water above a top surface of the filter media, and
a total filter volume greater than 16 cubic centimeters for water flowing through the filter media, wherein the total head height is greater than 2 inches when the top reservoir is full.

10. The gravity filtration assembly of claim 9, wherein particles of the filter media do not shift within the filter assembly.

11. The gravity filtration assembly of claim 9, wherein the head height is the distance from a top of the maximum water height to the top of the enclosure wherein the filter media is enclosed.

12. The gravity filtration assembly of claim 9, wherein water flows axially through the enclosure and the filter media.

13. The gravity filtration assembly of claim 9, wherein a uniform pressure of water is maintained on the surface of the filter media given any head pressure.

14. A filter having an immobilized gravity filter media arranged such that a pressure applied to a filter surface changes nearly uniformly as a head pressure in a filtration device changes, and water flows through the filter with a total filter volume greater than 16 cubic centimeters and a total pressure applied on the filter surface greater than 0.072 psi by gravity head pressure when the top reservoir is full.

15. An immobilized gravity filter configured to have a density of the filter equal to or greater than 0.43 g/cc.

16. The immobilized gravity filter of claim 15, comprising filter media.

17. A filter in claim 15 where the filter is angled slightly to allow for air on the bottom filter surface to float off to one side.
